(19) United States
(12) Patent Application Publication
(10) Pub. No.: US 2014/0143376 A1
(43) Pub. Date: May 22, 2014

(54) Method of Data Acquisition and Multi Directional Prioritized Data Dispersal for a Remote Drilling Site

(71) Applicant: Ryan Directional Services, Inc., Houston, TX (US)

(72) Inventors: Neal Beaulac, Houston, TX (US); Matthew White, Houston, TX (US); Walter Lombard, Houston, TX (US)

(21) Appl. No.: 14/083,112

(22) Filed: Nov. 18, 2013

Related U.S. Application Data
(60) Provisional application No. 61/728,160, filed on Nov. 19, 2012.

(51) Int. Cl. H04L 29/06

(52) U.S. Cl. CPC H04L 65/1003
USPC 709/217

(57) ABSTRACT

A method of transmitting data from a wellsite with unreliable data communications to a plurality of client servers includes intermediate communications via one or more remote servers. The remote servers may be cloud based servers. The method may include prioritization of data for communication across the most unreliable link to ensure timely transmission of the most critical data.

### CROSS-REFERENCE TO RELATED APPLICATIONS

This application is a non-provisional application which claims priority from U.S. provisional application No. 61/728,160, filed Nov. 19, 2012.

### TECHNICAL FIELD/FIELD OF THE DISCLOSURE

The present disclosure relates to the prioritized communication of data and commands between a drilling rig and a remote client.

### BACKGROUND OF THE DISCLOSURE

In the oil and gas industry, a typical drilling operation involves the collection and processing of large amounts of data. For example, tools lowered into the well borehole may obtain measurements of geophysical properties for the area surrounding the borehole. Mud logging may provide well owners and producers with information about the lithology and fluid content of the borehole. Drilling rate, mud weight, flow line temperature, oil indicators, pump pressure, pump rate, and gas levels may also be logged. Rate of penetration (ROP), weight on the bit, drill string weight, rotary speed, rotary torque, inclination, and azimuth angles may indicate the performance and progress of the drilling operation.

The information collected may be used both as real-time (or near real-time) data and as a log for trend analysis, and may be used to modify the drilling operation and determine well's future. Depending on the results, the well may be drilled deeper, plugged and abandoned, or cased and tested. The results of the log may also help determine whether the well requires stimulation or special completion techniques, such as gas lift or sand control.

These decisions are increasingly made off well-site. Remote viewing, which refers to the act of accessing rig specific and downhole tool information at a location other than the well-site, is increasingly being utilized to, for example, reduce the number of workers at the well-site, and centralize the decision making for multiple wells. Remote viewing may allow various industry experts the opportunity to review, analyze, and process the data in real-time to assist in making better decisions regarding well-site operations. In addition, by allowing operating and service companies to manage their data and services from a central office location, rig-site costs may be reduced, and operations may be improved through information sharing and collaboration, possibly allowing for quick investigations into and resolutions of rig -site issues.

### SUMMARY

The present disclosure provides for a method of transmitting data. The method may include collecting outbound data at a wellsite, outbound data being defined as data to be sent to a remote site; storing the outbound data; assigning a priority the outbound data; interrogating a wellsite network connection, the wellsite network connection being a network link between the wellsite and the remote site. If the wellsite network connection is operational, the method may include transmitting the outbound data in order of priority to the remote site.

The present disclosure also provides for a method of transmitting data. The method may include collecting outbound data at a wellsite, outbound data being defined as data to be sent to a remote site; storing the outbound data; assigning a priority to each datum of the outbound data; interrogating, at the wellsite, a wellsite network connection, the wellsite network connection being a network link between the wellsite and the remote site, and if operational transmitting the outbound data in order of priority to the remote site; collecting inbound data at the remote site, inbound data being defined as data to be sent to the wellsite; assigning a priority to each datum of the inbound data; interrogating, at the remote site, the wellsite network connection, and if operational transmitting inbound data to the wellsite; receiving, at the remote site, a request for specific data from a remote client; providing data from the remote site to the remote client; and if the specific data requested is not available in the remote server queuing, at the remote site, a request for specific data from the wellsite.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 illustrates a diagram representing a configuration of a network exemplary of an embodiment in accordance with the teachings of the invention.

FIG. 2 illustrates a diagram representing a configuration of a network exemplary of an embodiment in accordance with the teachings of the invention.

FIG. 3 illustrates a diagram representing a configuration of a network exemplary of an embodiment in accordance with the teachings of the invention.

FIG. 4 illustrates a series of logs to demonstrate a priority scheme for updating missing data in an exemplary embodiment in accordance with the teachings of the invention.

FIG. 5 is a flow chart for the acquisition and transmission of data in accordance with exemplary embodiment of the teachings of the invention.

FIG. 6 illustrates a diagram of a rig site local server network as an exemplary embodiment in accordance with the teachings of the invention.

FIG. 7 illustrates a prioritized thread sequence for data transmission in an exemplary embodiment in accordance with the teachings of the invention.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

For purposes of this disclosure, references to a network or the Internet are used interchangeably and may refer to, for example and without limitation, the Internet, public networks, private networks, private intranet, and/or virtual private networks including, for example and without limitation, electrical radio signals, optical signals, microwave signals, and/or hardwired signals. One skilled in the art would appreciate that remote clients, driller, company, and Remote Operating Centers (ROCs) all describe remote access for the purposes of this disclosure, and are considered synonymous for unless specific differences are indicated in context. Likewise, the local server, surface system, local database, and ruggedized computer may all describe a primary control computer located at or near a rig site and are considered synonymous for the purposes of this disclosure unless specific differences are indicated in context.

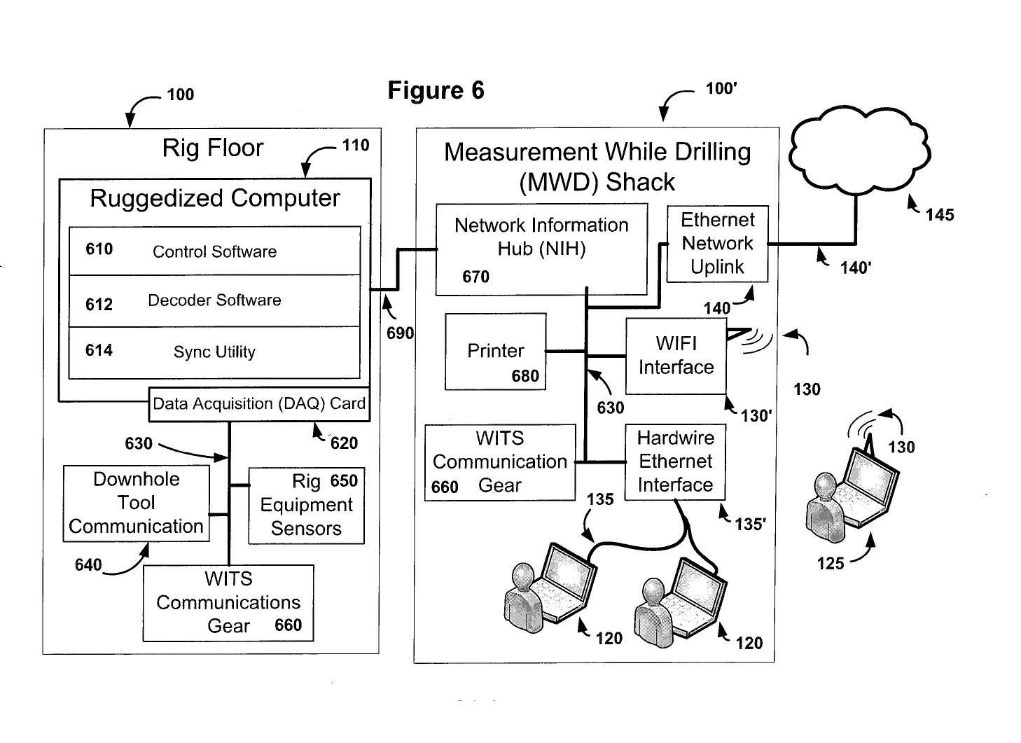

In some embodiments of the present disclosure, a wellsite includes a local network positioned to acquire data relating to, for example, drilling operations as well as control certain aspects of the operations of the wellsite. FIG. 6 depicts a block diagram of a local network consistent with embodiments of the present disclosure. Wellsite 100 includes local server 110. Local server 110 may utilize a Data Acquisition (DAQ) card 620 to communicate with downhole tools through downhole tool communication system 640; collect information from equipment around the rig through rig equipment sensors 650; and collect data from Wellsite Information Transfer Specification (WITS) enabled instrumentation through WITS communications gear 660. Local server 110 may utilize a communications channel 690 to transmit data to a Network Information Hub (NIH) 670 located, for example, in MWD Shack 100′. As understood in the art, local server 110 may be a computer server as understood in the art, and may include NIH 670. As understood in the art, individual components as discussed below may be spread among separate computer servers in the local network. For the purposes of this disclosure, local server 110 may include one or more computers.

In some embodiments, the local network may include one or more of the following components:

Local Server 110—Local server 110, which in some embodiments as depicted in FIG. 6 may be a hazardous-area certified or “ruggedized” computer, may be used to run ‘Control Software’ 610, ‘Decoder Software’ 612, and/or ‘Sync Utility’ 614. Local server 110 may be outfitted with Data Acquisition (DAQ) card 620, and radio 690 for communication with Network Interface Hub 670.

Control Software—Control software 610 may act as the user-interface between downhole tool communication 640 and anyone wishing to view downhole information. It may also interface with Sync Utility 614 to synchronize all job-related information on remote server 150 (not shown). Control software 610 may handle the prioritization of variables as discussed below.

DAQ Card—DAQ card 620 may acquire data from, for example, downhole tool communication 640, rig equipment sensors 650, and/or WITS communications gear 660. In some cases, this data may include analog signals (downhole tool data transmission signal) and, in some embodiments, DAQ card 620 may include an analog to digital converter to convert the acquired analog data into digital form. Data acquired may then be further processed by the Decoder Software 612.

Decoder Software—Decoder software 612 may translate the digital signal received from DAQ card 620 into information Control Software 610 may use for calculation and display purposes.

Sync Utility—Sync utility 614 may interface between local server 110 and a remote server as discussed below. It may also handle server calls from Control Software 610 (as well as control software at a remote client) for both storage and retrieval of information on local server 110. Sync utility 614 may also handle database storage and synchronization duties.

Network Interface Hub (NIH)—NIH 670 may provide a connection between local server 110 and wellsite network connection 140′. In some embodiments, NIH 670 may include one or more of, for example and without limitation, a wireless 900 MHz radio 690 to link with local server 110, a wireless Ethernet router 130′, an Ethernet switch 135′, an Ethernet network uplink 140, and an AC/DC power converter. It may be through the NIH 670 that local server 110 may be able to access the rig-site internet connection 140′. One skilled in the art would appreciate that different equipment could be placed in different locations around the rig site. For example, as depicted, in some embodiments NIH 670 may be located in MWD shack 100′. In other embodiments, NIH 670 may be located on the rig floor or in other locations depending on, for example, the housing of NIH 670, and the ability to supply the required communications and power connections.

NIH 670 may be connected by a communications interface 630 to, for example and without limitation, printer 680 for rendering local hardcopies of collected data; WITS Communication Gear 660; WIFI Interface 130′ for communicating with local wireless clients 125; and/or a hardwire Ethernet interface 135′ for communication with local clients 120.

In some embodiments, wellsite network connection 140′ may link local server 110 to one or more of the following without limitation:

Remote Server—Data acquired by local server 110 may be synchronized with a remote server. As discussed below, the remote server is connected to local server 110 through wellsite network connection 140′. The remote server may store the synchronized data for retrieval at any by a remote client. All information required to initialize Control Software 610 and display job information may be contained on the remote server. The remote server may receive data from Control Software 610 via Sync Utility 614 which utilizes NIH 670 to connect to wellsite network connection 140′. In some embodiments, NIH 670 may connect local server 110 with the Internet 145, through which data is synchronized with the remote server.

ROC and Client Office—Users at a Remote Operating Center (ROC) and/or at a Client Office may have the ability to connect to the remote server, and access information that has been stored thereupon. In some embodiments, the movement of the data from wellsite 100 to the remote server may increase availability of the data to remote personnel. For example, a user may be able to access the data at any time of the day, from anywhere in the world. Additionally, by moving the data from local server 110, multiple users, from any number of different locations may access this data simultaneously without interfering with rig-site activity as they interface only with the remote server. Thus, multiple users may have access to well information to analyze and interpret the data. Such access may, for example, enable better well management through information sharing and collaboration to solve any issue that may arise.

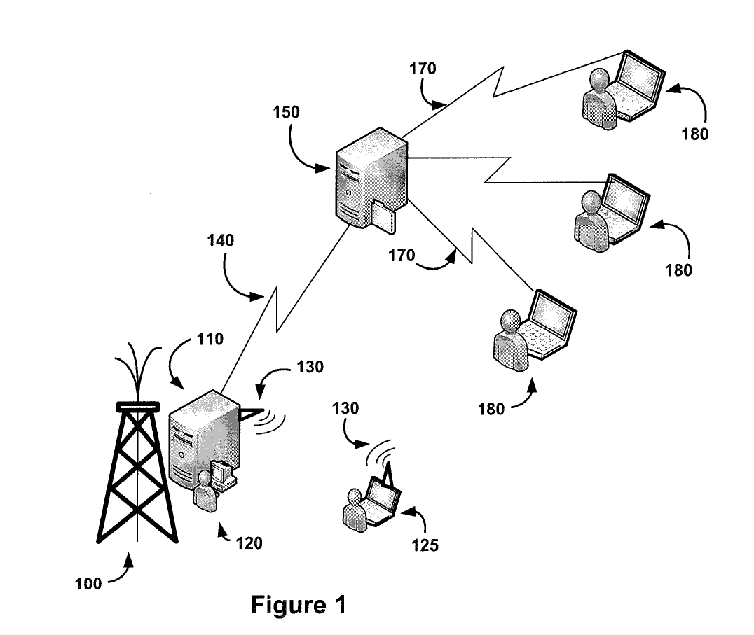

For example, as depicted in FIG. 1, in some embodiments of the present disclosure, data measured at wellsite 100 may be aggregated by local server 110. Although depicted as a single server, one having ordinary skill in the art with the benefit of this disclosure will understand that local server 110 may actually be multiple computers positioned to receive data at wellsite 100. Local server 110 may be locally monitored directly by local client 120. In some embodiments, local server 110 may include a wireless communication system 130, allowing for local monitoring by a wireless local client 125. Data aggregated by local server 110 may be stored locally on a hard drive in local server 110 and/or in local clients 120 125. Data aggregated by local server 110 may also be synchronized with remote server 150 via wellsite network connection 140. By synchronizing the data at an offsite location, any failure of local server 110 may not result in loss of synchronized data. As such, despite the potentially harsh environment at wellsite 100, local server 110 may not need to be “ruggedized” to account for, for example, vibration, power fluctuations, etc. as redundancy is built in to the system. Additionally, by storing data on local server 110 as well as on remote server 150, local clients 120, 125 may be able to continuously access the data regardless of the status of wellsite network connection 140.

In some embodiments, data may be synchronized not only from local server 110 to remote server 150, but also from remote server 150 to local server 110. For example, in some embodiments remote client 180 may be able to send notifications or display changes to local client 120 at wellsite 100 to alert local and near-by operators of various wellsite 100 conditions. In some embodiments, remote client 180 may be able to modify operations of wellsite 100 such as, for example and without limitation, rotational speed, WOB, or other drilling related parameters. In some embodiments, remote client 180 may be able to override decisions made by local operators. For example, an expert operator located offsite may be able to assume control of wellsite operations during a portion or all of a drilling operation

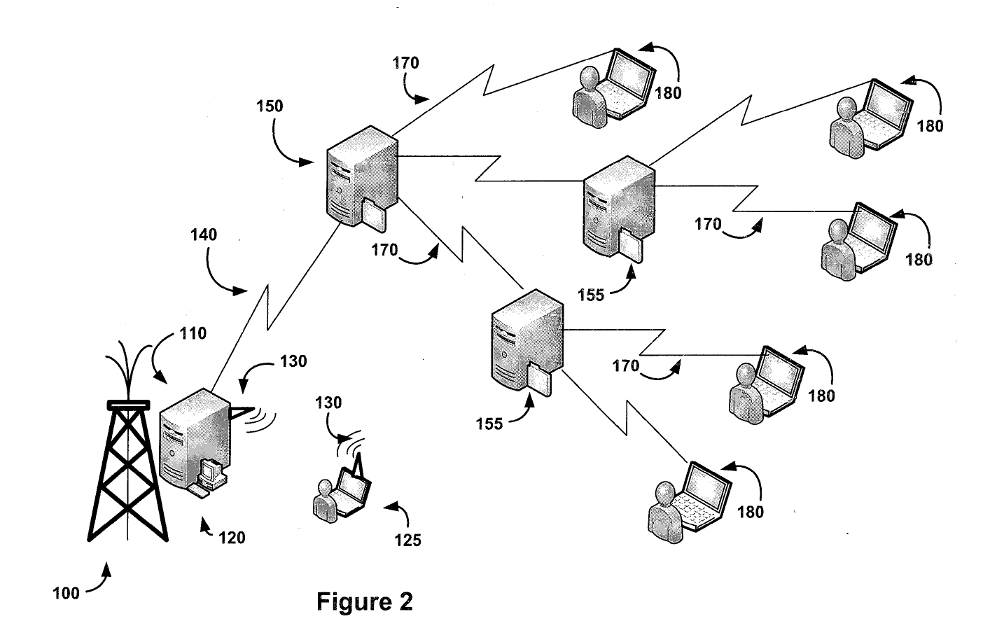

In some embodiments, remote server 150 may instead be a plurality of servers which further share data among themselves to, for example, allow access to multiple remote users without affecting the processing or operation of the severs as may result from, for example, overload of viewers. In such a configuration, as depicted in FIG. 2, remote sever 150, may communicate directly with wellsite 100. Remote server 150 may then communicate with secondary remote servers 155. Secondary remote servers 155 may then communicate with remote clients 180. Secondary servers 155 may also aggregate all data sent from remote clients 180 before sending the data to remote server 150. Remote server 150 may then aggregate any data received from secondary remote servers 155 (as well as any data received from any remote clients 180 connected directly to remote server 150) before forwarding the information to wellsite 100.

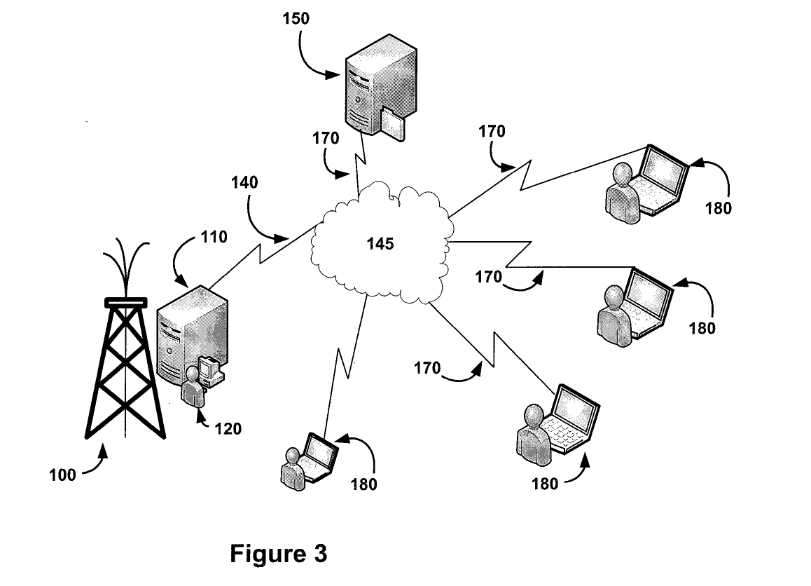

In some embodiments, the remote server may instead be a cloud based computer server. As understood in the art, a cloud based computer server may be one or more computer servers connected through a real-time communication network such as the Internet. As depicted in FIG. 3, for example, the internet 145 serves as the network for all communications. Wellsite network connection 140 serves to connect local server 120 to the internet 145. Such an arrangement may increase access to data from wellsite 100 and eliminate dependency on specific hardware at a remote client 180. Storing information on one remote server 150 also connected to the internet 145 may allow access of synchronized data at any time regardless of the state of wellsite network connection 140. Remote clients 180 use remote network connections 170 to connect to the internet 145 to interact with wellsite 100.

In some embodiments, remote server 150 may function as a storage location for wellsite data. In some embodiments, remote server 150 may function as an aggregation point for data traffic to be sent to wellsite 100. Remote server 150 may be connected to one or more remote clients 180 via remote network connections 170. Since remote clients 180 connect to remote server 150 via remote network connections 170 rather than to local server 110 directly, reliability of the data transmission to and from wellsite 100 may be improved. For example, in some cases, the reliability and bandwidth of wellsite network connection 140 may not permit the desired number of remote clients 180 to receive data from and issue commands directly to wellsite 100. In such a case, remote server 150 may act as a storage location for data from wellsite 100 and as an aggregator for wellsite 100 bound traffic. As such, only traffic between remote server 150 and local server 110 needs to be transmitted through wellsite network connection 140. To receive data from wellsite 100, remote clients 180 need only communicate with remote server 150 to retrieve data stored thereon. To issue a command to wellsite 100, commands need only be sent to remote server 150 which may then aggregate commands sent by all remote clients 180 to send to local server 110. Thus, the reliability of remote network connections 170 may be the only limiting factor in accessing well data and issuing commands to wellsite 100 from the viewpoint of remote client 180.

Remote server 150 may also provide clearing house functionality for data bound for wellsite 100, allowing any earlier undelivered data to be modified or replaced with subsequent data when necessary. A clearing house provides for a central location where such conflicting or interfering commands can be reconciled, and appropriate actions can be determined.

For example, a wellsite parameter able to be set remotely may have a parameter value of 50. Communications between remote server 150 and wellsite 100 are then interrupted. A first command is sent from remote client 180 to increase the parameter value from 50 to 75. After X amount of time, but before the first command can reach wellsite 100 due to the interruption in communications, a second command is sent from remote client 180 to reduce the parameter value from 75 to 60. Communications with the wellsite is then reestablished. The desired response in such a situation may be any of the following:
A) increase the parameter value to 75; wait X amount of time; then decrease the parameter value to 60;
B) increase the parameter value to 60;
C) query remote client 180 for confirmation of the desired action to perform;
D) perform one of the above based on the identity of remote client 180 issuing the command.

In such a case, the appropriate action may be decided by a preset instruction for reconciliation to the desired activity. Alternatively, the appropriate action may be decided by human interaction at a remote client 180 connected directly to remote server 150, at a remote client 180 connected to a secondary remote server 155, or at local client 120, 125. The appropriate action may be queried of the person submitting the conflicting actions, or the appropriate action may be a determination of the proper action based on the conflicting actions, the identities of those submitting the actions, and the time or specific value of the actions to take. Additionally, the appropriate action may be determined based on the age of the data on each remote client 180. For example, a command submitted from a remote client 180 having data which has not been updated for a predetermined amount of time may be automatically rejected as it is based on stale information.

In some embodiments, to account for an unreliable or low bandwidth wellsite network connection 140, data sent to and from wellsite 100 may be prioritized for synchronization. During a period in which wellsite network connection 140 is unreliable, smaller packets may increase the likelihood of uninterrupted transmission across an unreliable communication channel. Thus, small packets of real time data and/or more critical data may be more reliably transmitted via wellsite network connection 140 than large packets including more information. By prioritizing data for synchronization, remote users may be able to view critical information more reliably at the expense of less reliable viewing of less important information. Larger packets and/or less critical data may be prioritized lower so that they are transmitted during more reliable communications or at times when there is no higher priority data waiting to transmit.

In some embodiments, message length may also be taken into account with regard to, for example, the speed of the connection and the reliability of the connection. As understood in the art, messages conveying different data may vary in size. The size and the speed of the connection determine the amount of time a message will take to be transmitted. Based on, for example, the speed of the connection, large messages may be prioritized lower so as to allow shorter messages, able to convey more types of data in a shorter period of time, priority on wellsite network connection 140. In some embodiments, large messages may he broken into shorter messages. As such, when wellsite network connection 140 is unreliable, if a message is corrupted or otherwise not transmitted properly, the entire large message need not be resent in its entirety, as only the affected short message needs to be sent again. Additionally, by breaking the large message into shorter messages, in some embodiments, the large message may not tie up wellsite network connection 140 for its entire transmit time, allowing other messages with higher priority to be transmitted. For example, while a large message is being transmitted in its entirety, a short message with higher priority than the large message would have to wait for the whole large message to be transmitted. By breaking the large message into smaller messages, the higher priority message would be able to be transmitted between the smaller messages.

In some embodiments, the network bandwidth may be measured by sending a known-sized packet from, for example, the wellsite to the remote server or vice versa and measuring the time taken to receive and acknowledge the packet. In some embodiments, the network reliability may be measured by measuring the number of internet outages and the duration of each outage over the life of the wellsite operations. In some embodiments, more recent outages may be weighted more heavily to, for example, emphasize current network conditions. Using the probability of downtime over a given time interval as well as the measured bandwidth, the packet size and/or message length may be varied as previously discussed.

As an example, in some embodiments, each variable may be assigned a default priority level depending, for example, on the importance of the variable to the remote client. As an example, the following variables may be prioritized in accordance with the following table:

| Variable | Type | Priority |
|---|---|---|
| Toolface | Tool | 1 |
| Inclination | Tool | 1 |
| Weight on Bit | WITS | 2 |
| RPM | WITS | 3 |
| Persons on Site | Personnel | 9 |

In this example, the Toolface and Inclination variables may be assigned default priority levels of 1, indicating that they are the most important variables to be synchronized with the remote server under any bandwidth condition. The variable Weight on Bit is assigned a priority level of 2 indicating a slightly lower priority than Toolface, but higher than RPM with a priority level of 3. “Persons on Site” has a priority level of 9, which in this example is the least prioritized setting. This variable may, for example, have a low prioritization value because in relation to changes in the other variables, someone checking in or out of the rig site is a relatively rare occurrence. As personnel changes happen only a few times a day versus several times a minute for some other variable changes, it may be less important to have real time data for this variable: In the event current bandwidth does not allow synchronization of all data, then the highest priority data is synchronized first.

In some embodiments, any data that iS not synchronized is then analyzed to determine if priorities should be adjusted. For instance, although Persons on Site has a default priority of 9, if the variable has not been synchronized for more than, say, X minutes, the priority may be increased. Such an increase may prevent a situation known as starving, where sufficient bandwidth does not ever exist to “catch up” all data. This method of prioritization modification ensures that even low priority variables are updated on a regular basis.

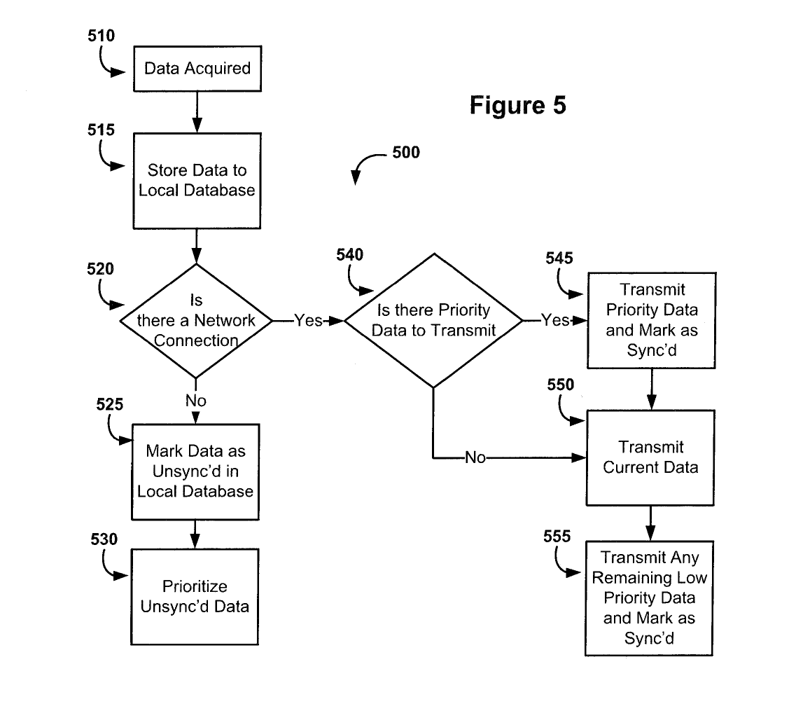

FIG. 5 depicts a flow chart of such a data acquisition and transmission operation 500 in accordance with embodiments of the present disclosure. As data is acquired (510), it is stored to local server 110 (515) at wellsite 100. Wellsite network connection 140 may be verified (520). If wellsite network connection 140 is not operational, data may be marked as unsynchronized in local server 110 (525) to indicate that it has not been transmitted to remote server 150. Unsynchronized data may be prioritized (530). As discussed herein, the prioritization level assigned may be changed at a later time. If wellsite network connection 140 is operational, any unsynchronized priority data may be detected (540) and is transmitted (545). The transmitted data may then be marked as synchronized. Subsequently, in some embodiments, current data is transmitted (550), followed by any additional unsynchronized lower priority data (555) (which is subsequently marked as synchronized).

In some embodiments, multiple threads are executed on local server, each thread corresponding with a priority level. Bandwidth is allocated to the threads in order of priority, with higher priority threads having the ability to preempt lower priority threads. Unsynchronized variables are assigned to threads based on their priority levels. As reprioritization occurs, a variable may be removed from one thread and reassigned to a higher priority thread so as to ensure it is synchronized in a timely manner. Multiple variables within the same priority thread may be prioritized based on their age, a sub-priority, or some other method of prioritization within the priority level.

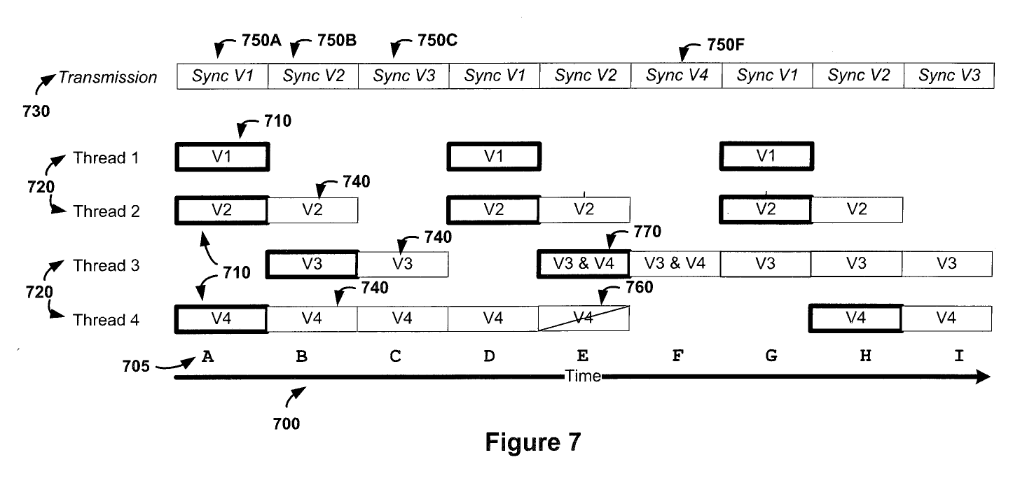

As an illustration, FIG. 7 depicts an exemplary prioritized thread sequence for data transmission from a wellsite to a remote server. In this embodiment, variables V1, V2, V3, V4 are to be transmitted to a remote server. One having ordinary skill in the art with the benefit of this disclosure will understand that variables V1, V2, V3, V4 may instead be transmitted from the remote server to the wellsite. Each variable V1, V2, V3, V4 may be assigned to a priority level, each priority level being assigned to a priority thread 720. FIG. 7 depicts four priority levels and four corresponding priority threads 720. The variables are acquired at a specific point in time 705 (acquisition depicted as heavy bordered box 710). If not synchronized, the variables may be stored until synchronization is permitted (storage depicted as light bordered box 740). Synchronization occurs when the highest priority thread is able to acquire transmission line resource 730 and synchronize its highest priority variable.

For illustrative purposes, time sequence 700 is broken into a period of discrete time blocks 705 (labeled A-I). Each time block 705 permits, for illustrative purposes, synchronization of a single variable and all operations associated with process maintenance.

During time period ‘A’, new values are acquired for Variables ‘V1’, ‘V2’, and ‘V4″ 710, which are assigned priorities 1, 2, and 4 respectively. Priority threads 720 each have a task of acquiring transmission line resource 730 to synchronize any variable assigned to the particular priority thread 720. During period ‘A’, Thread 1, being the highest priority thread, is able to accomplish this task as illustrated by the ‘Sync V1’ 750A activity on the transmission line. Threads 2 and 4 are blocked from acquiring transmission line resource 730, and thus store/hold their values for the next time cycle ‘B’.

During time period ‘B’, a new value is acquired for Variable ‘V3’, and variables ‘V2’ and ‘V4” remain from the previous time cycle. Thus Threads 2, 3, and 4 have variables to synchronize. As Thread 1 does not have variables waiting to synchronize, Thread 2 is able to acquire transmission line resource 730, and synchronize its associated variable as illustrated by the ‘Sync V2’ 750B activity on the transmission line resource 730. Threads 3 and 4 are blocked from acquiring transmission line resource 730, and thus store/hold their values for the next time cycle ‘C’.

During time period ‘C’, no new values are acquired, but variables ‘V3’ and ‘V4” remain from the previous time cycle. Thus Threads 3 and 4 have variables to sync. As Thread 1 and 2 do not have variables waiting to synchronize, Thread 3 is able to acquire transmission line resource 730, and synchronize its associated variable as illustrated by the ‘Sync V3’ 750C activity on transmission line resource 730. Although Variable V4 was acquired before V3, V3 has a higher priority and is therefore synchronized earlier. Thread 4 is still blocked from acquiring the transmission line resource 730, and thus stores/holds its value for the next time cycle ‘D’.

During time period ‘D’, new values are acquired for Variable ‘V1’, and variables ‘V2’. Although V4 has been around longer, it is still not synchronized because of higher priority data at time period ‘D’. In some embodiments, data which has been stored/held for a predetermined period, such as ‘V4’, may be granted a higher priority value than would otherwise be assigned. In an embodiment in which the predetermined period is four non-synchronization periods, at time period ‘E’, Variable ‘V4’ is removed from Thread 4 (at 760) and added to Thread 3 (at 770), meaning Thread 3 now has variables ‘V3’ and ‘V4’ to sync.

During time period ‘F’, Thread 3 is the highest priority thread with values to sync. It has ‘V3’ and ‘V4. ’ In this embodiment, the internal tie within the thread is decided by synchronizing values from oldest to newest, thus ‘V4’ is transmitted, as illustrated by ‘SyncV4’ 750F.

In some embodiments, certain variables may be reassigned a different priority in response to the magnitude of change, rate of change (first order derivative), or acceleration of change (second order derivative) in the value of the variable. This reprioritization may allow an end user to be alerted to important or potentially dangerous well-site conditions as indicated by rapidly changing variables sooner than the default prioritization would otherwise allow. Certain variables may always be so monitored, as recognizing such a variation in value may be critical to an end user. Examples include, but are not limited to: rate of penetration, weight on the bit, inclination and azimuth angles of the drill bit, rotational speed of the shaft, mud flow volume, and bottom-hole pressure.

As an example, if the rate of penetration (ROP) of a well remains relatively consistent during the drilling of a section of pipe, the data for the ROP may be reduced in priority. However, if the first derivative shows the ROP is increasing or reducing substantially the priority may be increased. Alternatively, if the second derivative of the ROP suddenly changes to zero, this may indicate a known stoppage or shutting down of drilling such as for a pipe change.

Another example may involve tracking the pump strokes of a mud pump in relation to the pump pressure over time. Changes in the ratio may indicate a potential pump failure by, for example, seal leakage. A large change occurring over a short period of time may indicate a complete failure of the pump such as a cracked housing or blown pipe.

Another example may be inclination dropping more than expected in a horizontal drilling section where the driller is attempting to maintain a ninety degree (90°) angle to the initial vertical well shaft. In such an example, a driller in an ROC may wish to be notified immediately if the inclination changes by more than 2-3° over a 100 foot interval. In another example, changes in wellbore azimuth over time may start small but quickly increase, which may indicate that the borehole may be trending in the wrong direction and miss the target zone. For example, the azimuth may change only 0.1-0.2° per 100 feet. Such a deviation may expand to 1-2° per 100 feet after 3 or 4 pipe stand, thus indicating that the tool may be being pushed in the wrong direction and, without correction, the target zone may be missed.

One skilled in the art would appreciate that there are many other methods which may be utilized to sub-prioritize within the thread, and that multiple different methods may be utilized based on a number of factors for a particular scenario and situation within the scope of this disclosure.

Additionally, although FIG. 7 depicts four priority thread and four variables, one having ordinary skill in the art with the benefit of this disclosure will understand that any number of priority threads and variables may be included within the scope of this disclosure. Furthermore, the number of threads and the number of variables need not be equal. As illustrated, a single thread may handle multiple variables and may utilize various methods of sub-prioritization to determine the order in which variables are synced. Additionally, the methods above illustrate synchronizing of one variable at a time, but one skilled in the art with the benefit of this disclosure would appreciate that multiple variables can be packaged into single transmission packets to eliminate the overhead of thread switching. Further, multiple threads could aggregate variables into a single packet thus lowering overhead resources. As illustrated through the example of ‘V4’, priorities may be dynamic and may be modified during the process based on extraneous factors, including but not limited to, time, variable value, client preferences, rig conditions, time of day, etc.

Additionally, although depicted as used during normal communications with continuous data acquisition, the prioritized thread sequence may be utilized when the network connection availability or bandwidth is not continuous. For example, in a case where network bandwidth is temporarily reduced significantly, fewer variables may be transmitted in a given time period. Because of the prioritization process, low priority data may not be synchronized for an extended period of time. When the network connection stabilizes, lower priority data may be synchronized utilizing the added bandwidth. In some embodiments, large gaps in data may be updated in an interlaced format so that a representation, even if lacking in detail, of the performance history is always maintained, and as more bandwidth is available, the representation can be further developed with higher resolution.

As another example, the rig site may completely lose network connection for a period of time. In some embodiments, once the network connection is restored, the first communications may be real-time current performance data according to the priority methods as previously discussed. Once a sufficient amount of current data is transmitted to the server, data gathered during the period of lost connectivity may then be updated. In some embodiments, the data gathered during the period of lost connectivity may be updated in chronological or reverse chronological order. In other embodiments, rather than starting with the oldest data first, and uploading every value in chronological order, representative values spread throughout the period of lost connectivity may be transmitted in smaller and smaller increments until all data is up to date.

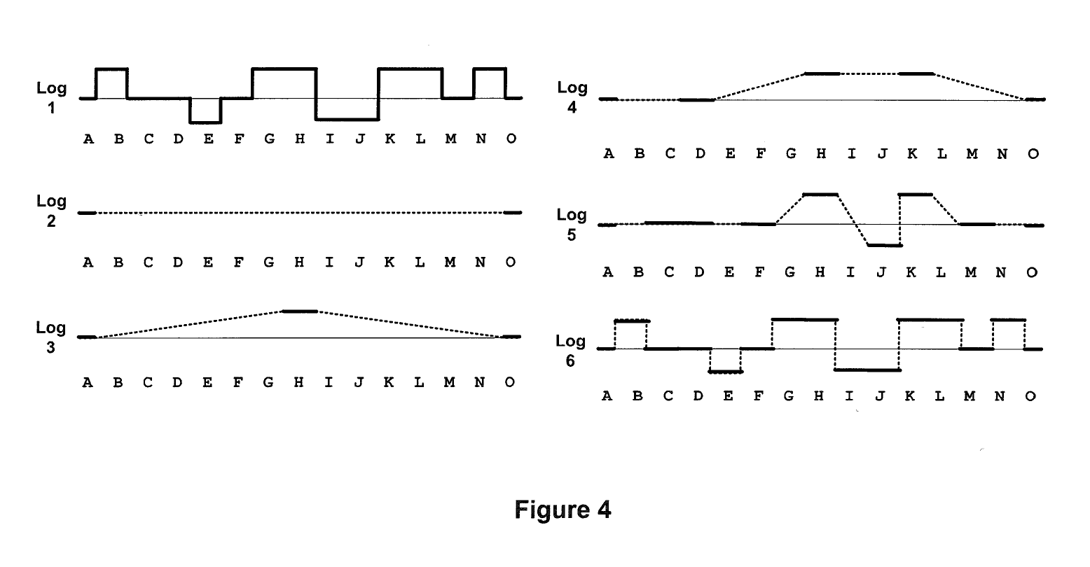

As an example of such an embodiment, FIG. 4 illustrates a series of logs to demonstrate a priority scheme for updating such missing data. Log 1 illustrates a series of variables recorded in a local database at a rig site. In a full-bandwidth scenario, this information would be forwarded to the remote server over a network connection in real- or near-real time. However, unreliability in the network connection may cause transmitted data to include periods for which data is missing. In some embodiments, until all data is available on the remote servers, the remote clients may approximate the missing data based on known data.

One method of approximation may be to average the data over the missing timeframes. In one embodiment, a time frame of missing data is identified, as illustrated in Log 2, for time periods B-N. Actual data for time periods A and 0 are known. Data for time periods B-N are estimated and projected by mathematical approximations based on the known values. As illustrated in Log 2, since the value at A and 0 are the same, the values from B-N are projected to be the same as A and O.

Once network connectivity is restored rather than synchronizing data from times B-N in chronological order, the missing data is transmitted according to one or more paradigms. One method of generating more accurate approximations may be to minimize the time periods over which the values must be averaged. This is done by prioritizing the transmission of values near the middle of time periods of missing values. Log 3 illustrates an updated version of the data in Log 2 where the data from time period H has been updated on the remote server so that the values between B and G are averaged, and I-N are averaged. In such an embodiment, the values at D and L are projected to be half the values difference between the known values.

Log 4 illustrates the approximations after update of data from time periods D and K. Log 5 illustrates the approximations after update of data from time periods C, F, J, and M. Log 6 illustrates the final update in which the remote values illustrated in Log 6 are accurate representations of the actual data in Log 1.

One having ordinary skill in the art with the benefit of this disclosure will understand that one or more paradigms for missing data synchronization may be utilized for different variables. For example, in some embodiments, one variable may be synchronized in chronological order while a second variable is synchronized as described above with respect to FIG. 4. Additionally, although described as an average, one having ordinary skill in the art with the benefit of this disclosure will understand that unknown data points may instead by interpolated from known data points by other means, including variable-specific models. Furthermore, although the example described with respect to FIG. 4 synchronizes data to split each data gap more or less in half, the order for synchronization of data for the communication gap may be prioritized based on a different calculation, such as, for example and without limitation, the second the first time derivative of the data values. In such an embodiment, time periods including changes in data may be synchronized to the remote server earlier than non-changing data. Under the presumption that steady values may be closer to the previously mentioned predictions, a more thorough and accurate data sequence may thus be available on the remote server more quickly. In some embodiments, by knowing the algorithm the remote server is using to interpolate data, a decision to omit certain unchanging from synchronization may be made. For example, where averaging is utilized by the remote server and the data for a variable is unchanged for a series of data points, the synchronization of the intervening data points may be ignored, as the reconstruction done by the remote server already corresponds with the actual data without the intervening data points.

In some embodiments, a prioritization profile may be used to, for example, temporarily prioritize selected variables in response to certain measured conditions in order to ensure those variables are synchronized rapidly. For example, if an Inclination value changes by more than 10° in a 100 ft. interval, the driller may want this information conveyed to a remote operating center immediately. In this situation, the control software may monitor inclination changes over 100 ft. depth intervals, temporarily change the synchronization priority level of the Inclination variable to a higher level (potentially user-defined), synchronize the local computer with the remote computer, and return the Inclination priority level to the previous value upon successful synchronization. The control software may have the ability to monitor changes over time/depth (1st order derivative), how fast certain variables are changing (2nd order derivatives), and any combination thereof, and make dynamic synchronization prioritization changes as necessary.

In some embodiments, prioritization profiles may increase the priority of a selected group of variables in response to certain measured conditions or wellsite operations. In normal operations, such variables may be of relatively low priority, or may be non-uniformly prioritized. For example, if measured depth is declining rapidly and no new real-time data has been received from the downhole tool for an extended period of time, it may indicate that the tool is tripping out of the borehole, at which point a group of variables which may be important to monitor during a tripping out operation may be increased in priority. Examples of situations which may have specific prioritization profiles may include without limitation tripping out of the borehole, sliding within the borehole, high ROP periods, build sections, etc. At other times, a default prioritization profile may be used. Dynamic changing to prioritization of individual variables, as previously discussed, while a prioritization profile is active may still apply. Prioritization profiles may provide the control software a predetermined way to, for example, change back and forth between the default prioritization profile and a situation specific prioritization profile. In some embodiments, a client may also have the ability to change the priority level of any variable from both the rig-site and from a remote client.

In some embodiments, a variable may be prioritized in response to a request from any one of the local server, the remote server, a local client, or a remote client.

The flowcharts, network schematics, and diagrams in accordance with exemplary embodiments of the present invention are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention. Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory (such as memory of the handheld portable electronic device) and accessed by the processor using the bus. The techniques and methods for embodying software programming code in memory, on physical media, and/or distributing software code via networks are well known and will not be further discussed herein.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A method of transmitting data comprising;
collecting outbound data at a wellsite, outbound data being defined as data to be sent to a remote site;
storing the outbound data;
assigning a priority the outbound data;
interrogating a wellsite network connection, the wellsite network connection being a network link between the wellsite and the remote site, and if operational:
transmitting the outbound data in order of priority to the remote site.

2. The method of claim 1 further comprising:
collecting inbound data at the remote site, inbound data being defined as data to be sent to the wellsite;
assigning a priority to inbound data;
interrogating the wellsite network connection, and if operational:
transmitting inbound data to the wellsite.

3. The method of claim 2 further comprising:
receiving a request for specific data from a remote client;
providing data from the remote site to the remote client; and if the specific data requested is not available in the remote server:
queuing a request for specific data.

4. The method of claim 2 further comprising:
receiving commands for wellsite operations from a remote client, the commands for wellsite operations corresponding to requested wellsite behaviors;
identifying commands which conflict with other commands;
determining desired wellsite behavior with respect to any commands identified as conflicting for wellsite operations;
creating the desired command with respect to the desired wellsite behavior.

5. The method of claim 4 wherein determining desired wellsite behavior comprises:
aggregating requested wellsite behaviors into a single command.

6. The method of claim 4 wherein determining desired wellsite behavior comprises:
determining an authority of each remote client requesting each conflicting command, and taking action of the most authoritative remote client's issued command from the conflicting commands.

7. The method of claim 4 wherein determining desired wellsite behavior comprises:
notifying a first remote client of at least one conflicting command from a second remote client;
querying the first remote client for a resolution for the series of conflicting commands.

8. The method of claim 2 further comprising:
receiving a request for specific data from a secondary remote server, the secondary remote server functioning as a hub for at least one remote client in communication with the secondary remote server, the secondary remote server aggregating requests and commands from a remote client connected thereto.

9. The method of claim 4, further comprising:
notifying a first remote client of at least one conflicting command from a second remote client;
querying the first remote client for a resolution for the series of conflicting commands.
transmitting the command selected by the first remote client to the wellsite.

10. The method of claim 1 wherein collecting outbound data further comprises one or more of the following:
receiving data from a downhole sensor, tool, or wellsite equipment;
receiving data and commands from a local client;
receiving data from a nearby client;
analyzing data across time periods to determine a trend;
calculating first order derivatives of the collected data;
calculating second order derivatives of the collected data;
collecting weather and other environmental conditions at the surface of the wellsite; and
collecting environmental conditions along the well bore.

11. The method of claim 1 wherein assigning a priority further comprises:
assigning default priorities to newly received data;
modifying the default priorities based on trends or conditions identified at the wellsite;
reviewing previously received data and modifying the current priorities based on one or more of the following:
trends or conditions identified at the wellsite;
request from a remote client for specific data;
trends or conditions identified in consideration of newly received data;
time since the data was received.

12. The method of claim 1 wherein interrogating a network connection link comprises:
testing communication to the remote site;
if necessary, reestablishing the communication link;
if necessary, initializing alternative communication links; and
testing communication to the remote site; and
if necessary, attempting communication to a secondary remote server.

13. The method of claim 1 wherein interrogating a network connection link comprises:
transmitting a packet of a known size to the remote site;
measuring the length of time taken to receive the packet at the remote site;
calculating the bandwidth of the communication link.

14. The method of claim 1 wherein interrogating a network connection link comprises:
testing communication to the remote site;
logging the number of disconnections from the remote site;
logging the duration of the disconnections;
calculating a probability of downtime over a given time increment.

15. The method of claim 14, further comprising calculating a maximum package size or maximum message length.

16. The method of claim 1 wherein transmitting the outbound data in order of priority further comprises:
determining the highest priority level of data on the local server;
transmitting the highest priority data;

17. The method of claim 2 wherein the transmitting operations further comprise:
determining the highest priority level of outbound data;
determining the highest priority level of inbound data;
comparing the highest priority level of outbound and inbound data;
transmitting the highest priority data.

18. The method of claim 1 wherein the outbound data comprises a sequence of data, each datum in the sequence of data corresponding to a time, and the assigning operation further comprises assigning priority to each datum.

19. The method of claim 18 further comprising:
reconstructing, by the remote site, the sequence of data based on partial data received by the remote site as each datum in the sequence of data is transmitted.

20. The method of claim 19 wherein the restructuring operation comprises:
generating estimated values for each datum in the sequence of data not yet received by the remote site based on the data of the sequence of data that have been received, the estimated values generated by interpolation.

21. The method of claim 20 wherein each datum in the sequence of data is prioritized to maximize the accuracy of the estimated values.

22. The method of claim 18 wherein each datum in the sequence of data is prioritized with respect to the time values of each datum of the sequence of data, the priority assigned according to one of:
prioritizing the datum at the middle of the sequence of data;
prioritizing a maximum or minimum datum of the sequence of data; or
prioritizing a subsequence of datum based on one of:
an absolute change in value of adjacent data of the subsequence of data; or
a change in first or second order derivative of the values of data in the subsequence of data.

23. The method of claim 1, wherein the assigning operation further comprises:
determining a wellsite operation;
assigning priority to a datum of the outbound data based on the wellsite operation.

24. The method of claim 1, wherein the assigning operation further comprises:
determining a measured condition from the outbound data;
assigning priority to a datum of the outbound data based on the measured condition.

25. The method of claim 24, wherein the measured condition is based on one of:
a value of a datum which is over or below a set threshold value;
an absolute change between data representing a single variable; or
a first or second order derivative value calculated between data representing the single variable.

26. The method of claim 1, wherein the assigning operation further comprises:
determining the amount of time that has passed since the last datum corresponding to a variable was transmitted;
prioritizing a datum of the outbound data corresponding to the variable based on the determined amount of time passed.

27. The method of claim 1, wherein the outbound data comprises at least one message, the message including a series of packets, and the method further comprises:
determining the size of a message; and if the message is larger than a predetermined threshold size:
separating the message into a plurality of smaller messages.

28. A method of transmitting data comprising;
collecting outbound data at a wellsite, outbound data being defined as data to be sent to a remote site;
storing the outbound data;
assigning a priority to each datum of the outbound data;
interrogating, at the wellsite, a wellsite network connection, the wellsite network connection being a network link between the wellsite and the remote site, and if operational:
transmitting the outbound data in order of priority to the remote site;
collecting inbound data at the remote site, inbound data being defined as data to be sent to the wellsite;
assigning a priority to each datum of the inbound data;
interrogating, at the remote site, the wellsite network connection, and if operational:
transmitting inbound data to the wellsite;
receiving, at the remote site, a request for specific data from a remote client;
providing data from the remote site to the remote client; and if the specific data requested is not available in the remote server:
queuing, at the remote site, a request for specific data from the wellsite.
